(19) United States
(12) Patent Application Publication
(10) Pub. No.: US 2005/0230934 A1
(43) Pub. Date: Oct. 20, 2005

(54) Method of making a modular vehicle and a modular vehicle

(76) Inventor: H. William B. Wilt, Valleyview (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/097,117

(22) Filed: Apr. 1, 2005

(30) Foreign Application Priority Data
Apr. 2, 2004 (CA) 2,463,044

(51) Int. Cl. B62D 59/00

(52) U.S. Cl. 280/400

(57) ABSTRACT

A method of making a modular vehicle is described. A first step involves maintaining an inventory, comprising: chassis modules; wheel and suspension modules including steer-able wheel and suspension modules having steering capability, drive wheel and suspension modules having an internal drive adapted to rotate the wheel; motor modules to provide motive force to drive components; and control modules having a driver compartment with steering controls and motor controls. A second step involves assembling the modular components to meet the particular needs of a customer.

### FIELD OF THE INVENTION

The present invention relates to a method of making a modular vehicle from combinations of specified modular components which can be configured by a distributor to suit the particular needs of a customer and subsequently reconfigured by the customer should those needs change.

### BACKGROUND OF THE INVENTION

It is impossible to meet the needs of all potential purchasers with one style of vehicle. Each industry sector, such as forestry, oil and gas, mining, and agriculture, has different needs. Furthermore, within a given industry sector, the needs may change during the course of a project. Initial phases of a project involve site reconnaissance and surveying. For this initial phase, light payload personnel carriers are required. A construction phase of a project may require hauling of heavy or bulky materials and machinery. For this construction phase, heavy payload cargo carriers are required.

### SUMMARY OF THE INVENTION

What is required is a method of making a modular vehicle from combinations of specified modular components which can be configured by a distributor to suit the particular needs of a customer and subsequently reconfigured by the customer should those needs change.

According to one aspect of the present invention there is provided a method of making a modular vehicle. A first step involves maintaining an inventory, comprising: chassis modules having opposed sides and opposed ends; wheel and suspension modules including steer-able wheel and suspension modules having steering capability, drive wheel and suspension modules having an internal drive adapted to rotate the wheel, and dual function wheel and suspension modules having both steering capability and drive capability; motor modules to provide motive force to drive components; and control modules having a driver compartment with steering controls and motor controls. A second step involves assembling the modular components to meet the particular needs of a customer. This assembly involves coupling at least two chassis modules in end to end relation by a coupling which permits pivotal movement about a substantially vertical pivot axis, while accommodating pitch and yaw. It further involves detachably mounting a control module on one of the at least two chassis modules. It also involves detachably mounting a motor module on one of the at least two chassis modules. It finally involves detachably mounting wheel suspension modules having required steering and drive performance characteristics to the opposed sides of each of the at least two chassis modules in a manner which supports movement of the chassis modules over a ground surface.

The production of a new vehicle is a costly process. The new vehicle must be designed and manufactured. The distributors must then support the new vehicle by stocking a replacement parts inventory and training sales and mechanical support staff. There is a significant advantage for distributors to be able to stock a relatively small number of component modules, which enable them to meet diverse customer needs. This approach also provides a benefit to customers, who can have their vehicles reconfigured, should their needs change. The metamorphosis of these vehicles can be dramatic. As will hereinafter be further described, by adding or substituting chassis modules, the length of the vehicle and the width of the vehicle can be altered; with the resultant changes to the vehicles functionality and load capacity.

This has a secondary but not less significant benefit of maintaining value in the subsequent reselling of the vehicle. In the traditional market once a machine model is sold it stays substantially in that configuration until the end of its useful life. According to the benefits of this invention when the original owner places the machine on the used market, anyone may purchase the used machine knowing that the modules are compatible with their current need/inventory regardless of the machine's previous configuration.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a first embodiment of modular vehicle constructed in accordance with the teachings of the present method.

FIG. 2 is a perspective view of a second embodiment of modular vehicle constructed in accordance with the teachings of the present method.

FIG. 3 is a perspective view of a third embodiment of modular vehicle constructed in accordance with the teachings of the present method.

FIG. 4 is a perspective view of a fourth embodiment of modular vehicle constructed in accordance with the teachings of the present method

FIG. 5 is a perspective view of a fifth embodiment of modular vehicle constructed in accordance with the teachings of the present method.

FIG. 6 is a perspective view of a sixth embodiment of modular vehicle constructed in accordance with the teachings of the present method.

FIG. 7 is a perspective view of a sixth embodiment of modular vehicle constructed in accordance with the teachings of the present method.

FIG. 8 is a perspective of a wheel and suspension module constructed in accordance with the teachings of the present invention.

FIG. 9 is a perspective of a wheel and suspension module with steering capability constructed in accordance with the teachings of the present invention.

FIG. 10 is a perspective view of a seventh embodiment of modular vehicle constructed in accordance with the teachings of the present method

### DETAILED DESCRIPTION OF THE PREFERRED EMBODIMENT

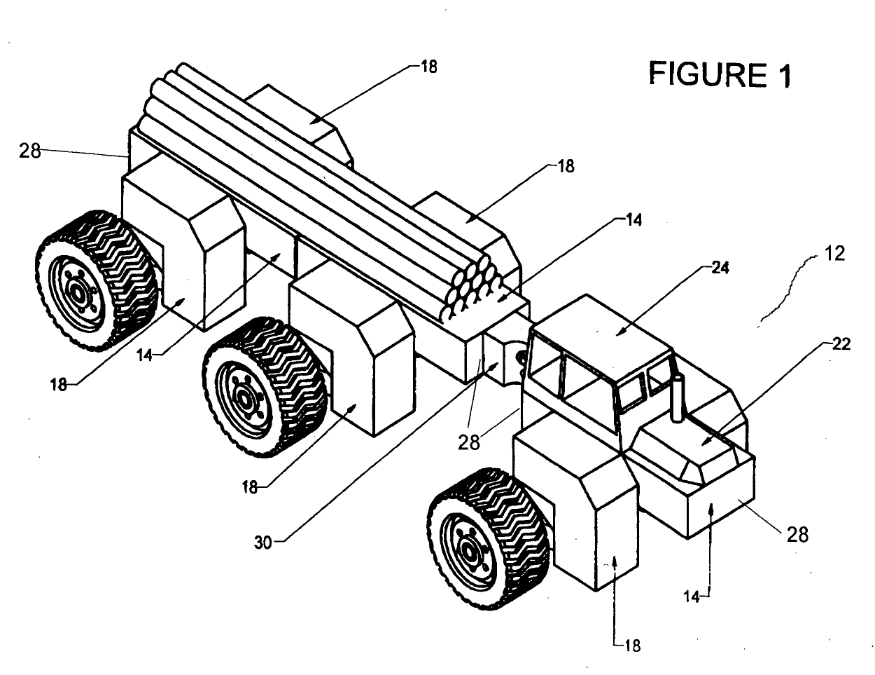

The preferred method of making a modular vehicle will now be described with reference to FIGS. 1 through 10.

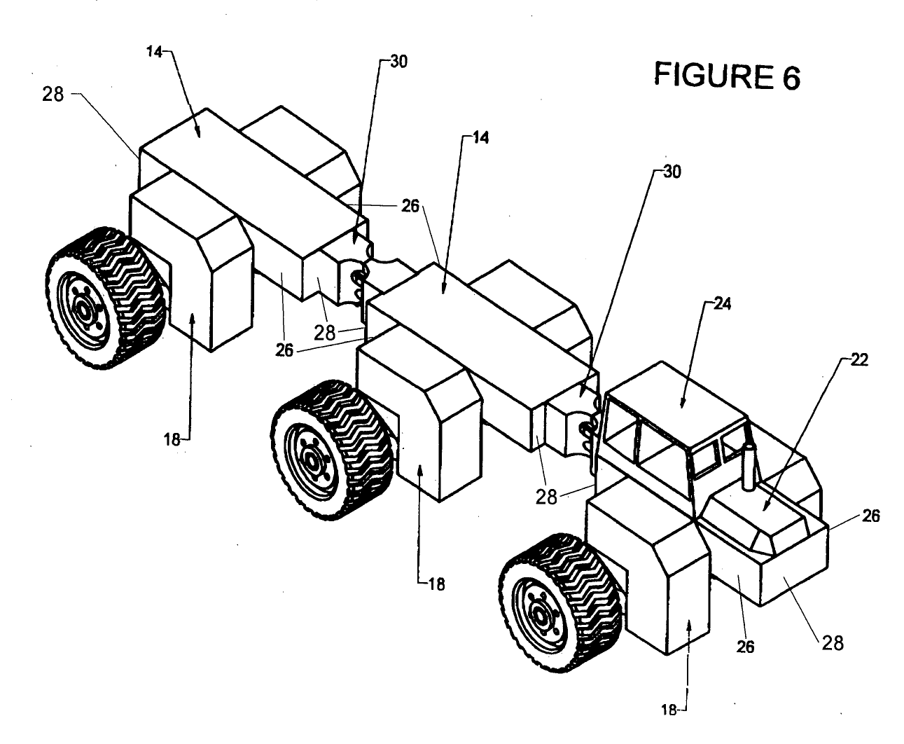

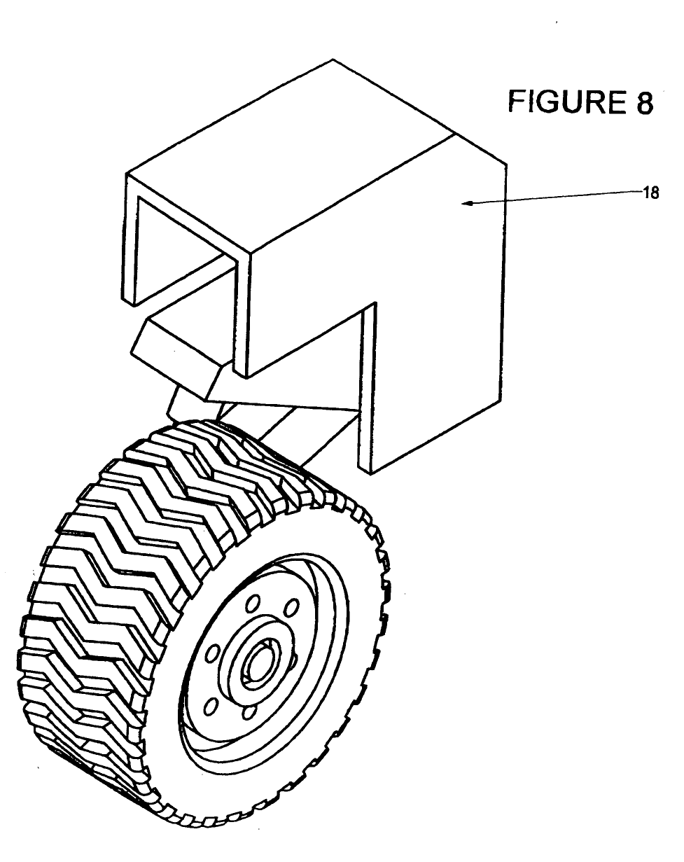

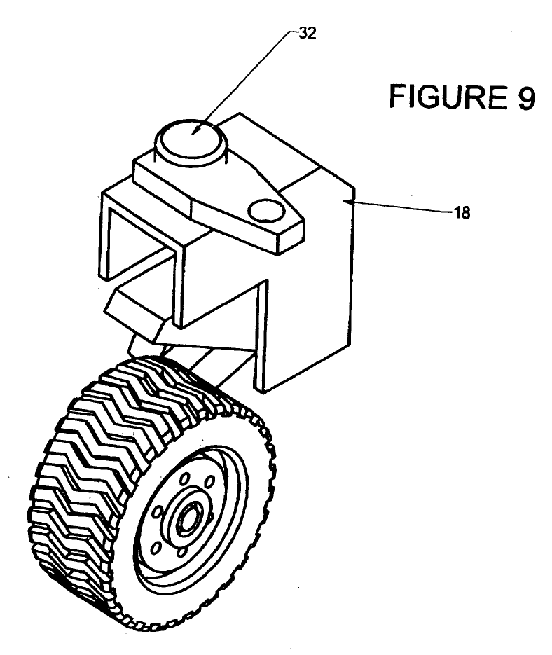

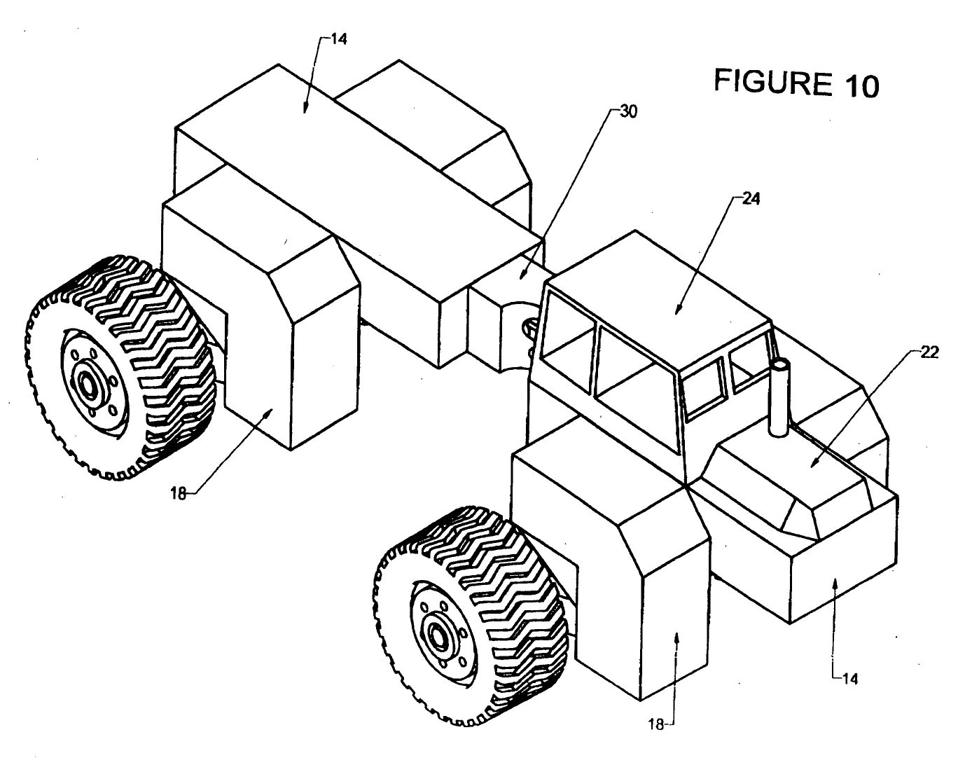

There will hereinafter be described how various configurations of vehicles can be made by attaching together a relatively few number of component modules maintained in a distributors inventory. Referring to FIG. 1, there is illustrated a truck, generally indicated by reference numeral 12. The modular components which have been used to construct truck 12 include three chassis modules 14, six wheel and suspension modules 18 on rear chassis module 16, a coupling module 30 that permits pivotal movement about a substantially vertical axis and that may also be accessorized such that coupling module 30 also provides means for articulated steering, a power source (engine) module 22 that provides motive force to wheel drive components, and a control module 24 having a driver compartment, steering and motor controls (not shown). As shown in FIG. 1, the chassis modules 14 may either be attached to each other or attached to the coupling module 30 from either end of the chassis module 14. The modules may be detachably mounted together by bolts. There are also wheel and suspension modules 18 on chassis modules 14. Wheel and suspension modules 18 may have steering capability, drive capability through an internal drive adapted to rotate the wheel (not shown), or both, depending on the intended application. Referring to FIG. 6, each of chassis modules L4 have opposed sides 26 and opposed ends 28. Referring to FIG. 1, the front two chassis modules 14 are coupled in end 28 to end 28 relation by a coupling 30, which permits pivotal movement about a substantially vertical pivot axis, while accommodating pitch and yaw. Referring to FIG. 8, the basic configuration of wheel and suspension module 18 is illustrated. Referring to FIG. 9, there is illustrated how an additional steerable pivot 32 is added to wheel and suspension module 18 to provide the added function of steering capability. Wheel and suspension module 18 may or may not include an internal drive to rotate the wheel, depending upon the intended application. With each vehicle, wheel suspension modules having required steering and drive performance characteristics are secured to opposed sides 26 of each chassis module 14 to support movement of chassis modules 14 over a ground surface. Referring to FIG. 10, there is illustrated the vehicle of FIG. 1 without the third module 14 at the end.

There will now be described how the above described modular components can be configured to suit other customer applications. In order to avoid redundancy in the description, identical components will be identified by identical reference numerals. When one examines various vehicle configurations there are a number of choices which may be made:

Drive wheel components: vehicles can have front wheel drive, rear wheel drive or all wheel drive, or “on the go” selection of any configuration above. The combination chosen is governed by the customer need and because of modularization may be altered at any point in the future.

Steering components: vehicles can have articulate steering as shown by module 30 or independent wheel and suspension module steering as shown by FIG. 9 where module 18 is accessorized with module 32 to create a steerable suspension module 20. Vehicles can have articulated steering through module 30 or pivot axis steering through module 20 or any combination of both as required by the customer and likely governed by the trade-off's between vehicle control and economy.

Chassis components: vehicle can have two, three or more chassis modules, where the number of chassis modules is dictated by the load requirements and the ground pressure tolerable to the job task. Traditionally wider tires have been used to reduce ground pressure and may also be applied to this invention. This becomes complex in that transportation of wide loads on highways to the work site often necessitates the removal and reinstallation of wide flotation tires at the remote work site. This invention offers an alternate solution in situations where transportation costs or width of access limitations are factors, in that more modules can be added relatively easily. It is also noted that the suspension module may be equipped with commercially available short tracked units rather than rubber tires as extreme ground pressure limitation may require. FIG. 10 illustrates two chassis modules 14 and 16 while FIG. 1 illustrates a configuration to which a third chassis module 34 has been added.

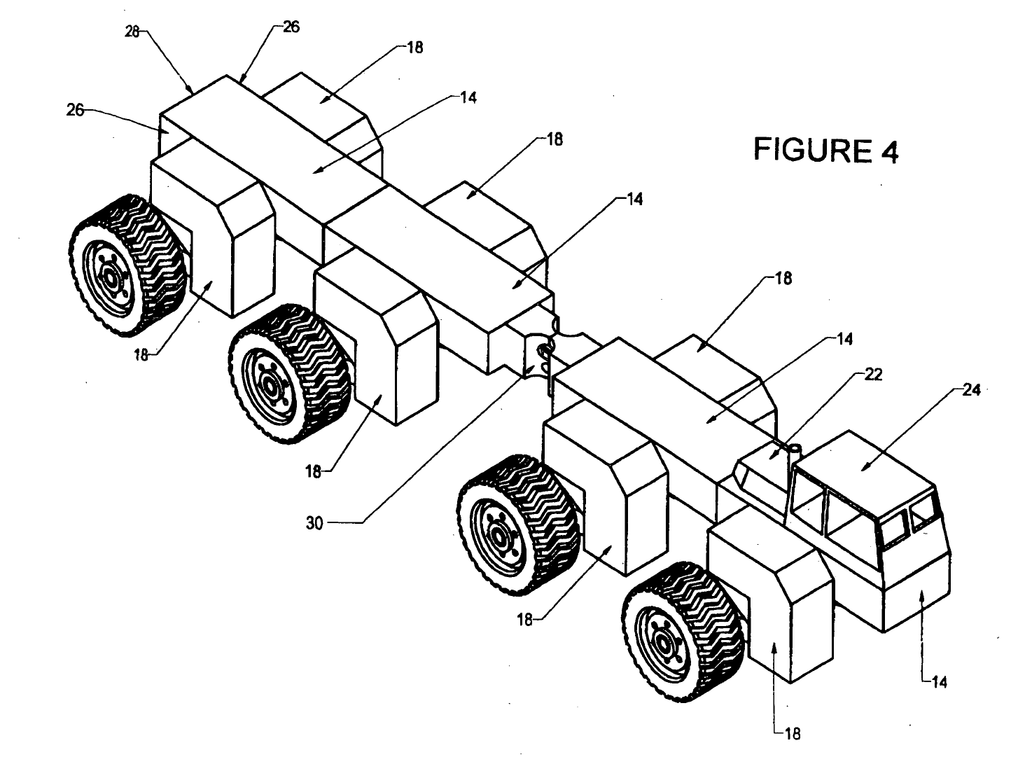

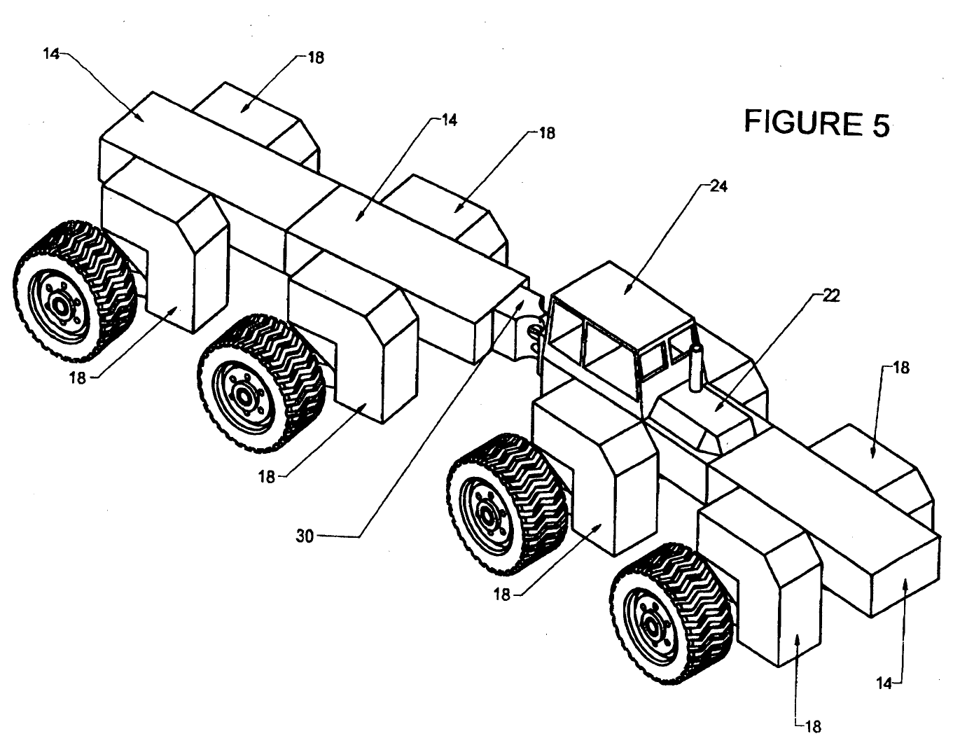

Wheel configurations: a vehicle with two chassis components can have two wheels on the front chassis and two wheels on the rear chassis, four wheels on the front chassis and two wheel on the rear chassis, two wheels on the front chassis and four wheels on the rear chassis, four wheel on the front chassis and four wheels on the rear chassis. Referring to FIG. 6, there is illustrated a configuration in which each of chassis modules 14, 16, and 34 has two wheels. Referring to FIG. 1, there is illustrated a configuration which has two wheels on front chassis 14 and four wheels on rear chassis 16. Referring to FIGS. 4 and 5, there are illustrated configurations which have four wheel on front chassis 14 and four wheels on rear chassis 16. Although not illustrated, it will be appreciated that with an appropriate embodiment a configuration can be made with four wheels on the front chassis and two wheels on the rear chassis.

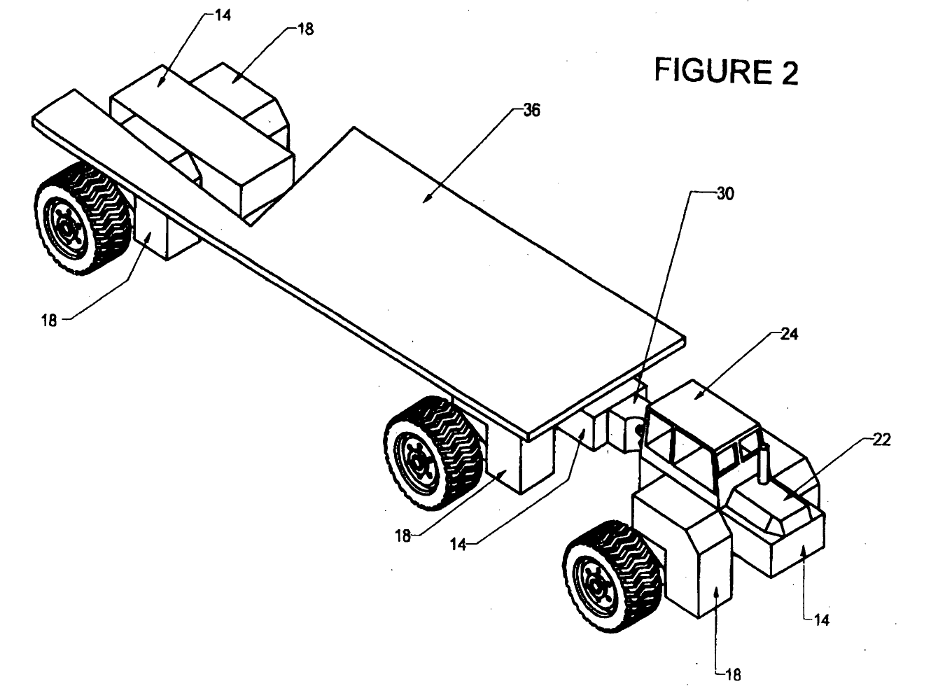

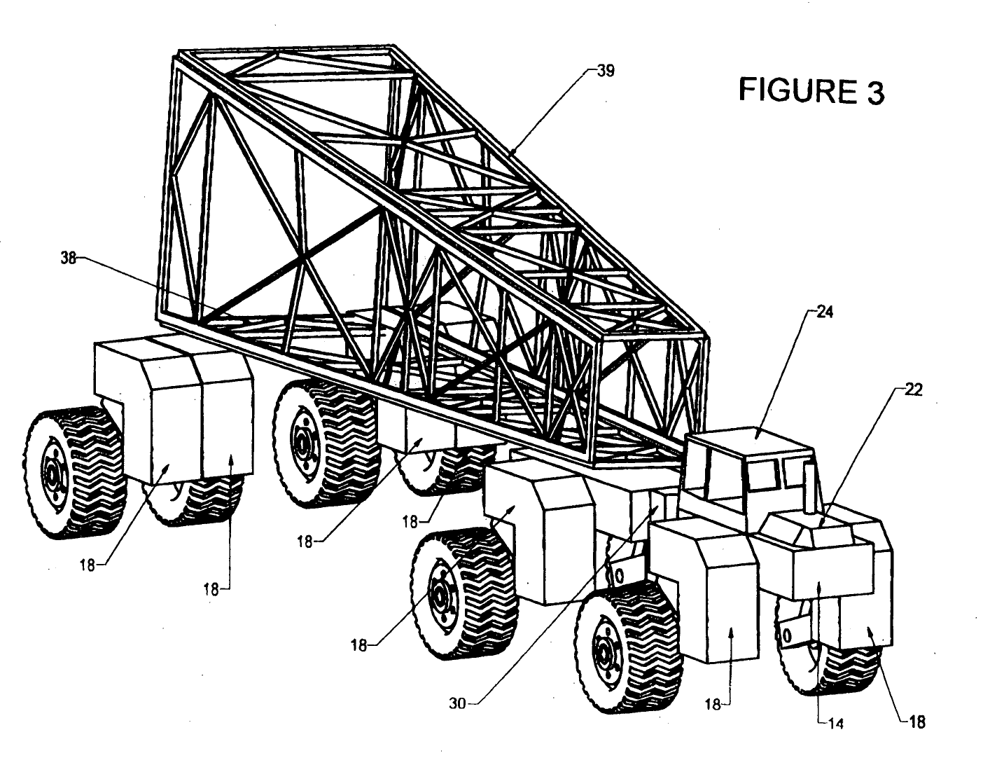

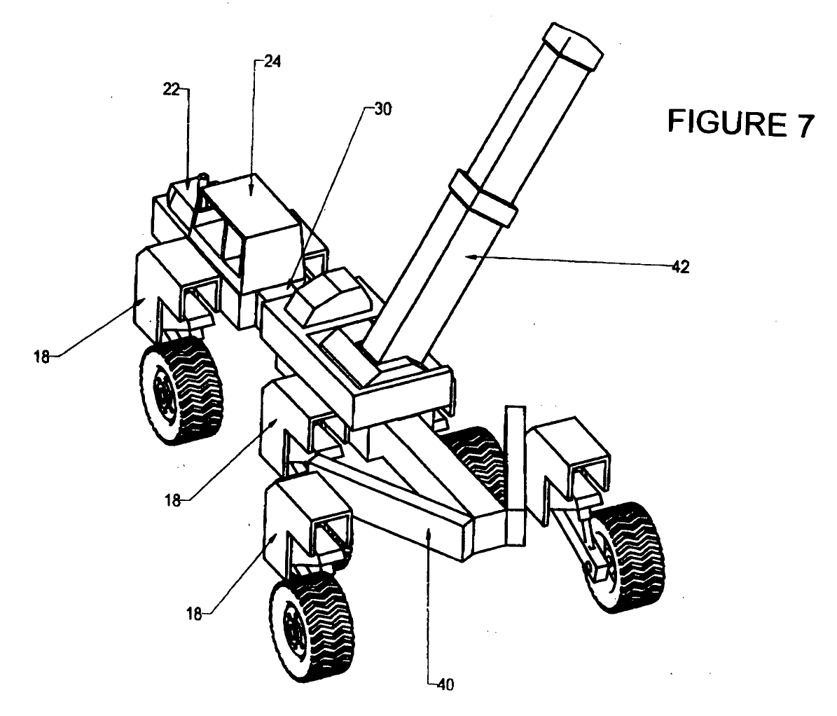

Chassis characteristics: chassis components will vary in length and width to suit particular applications. Referring to FIG. 1, a short flat deck is illustrated which can have many functions. The illustrated load of logs 35, this could also represent a load of pipe. Referring to FIG. 2, it is shown how a vehicle with the capability of carrying long loads can be arranged by either fabricating an extra long chassis module or by securing a bridge member 36 that spans between chassis modules 16 and 34. Referring to FIG. 3, it is shown how wheel suspension modules 18 can be placed in a wider stance, by selection of an extra wide chassis module 38. As illustrated, the extra wide stance is needed to handle a derrick component 39 of a drilling rig. FIG. 7 illustrates how a customized chassis module 40 is prepared to meet the needs of particular applications. The illustrated chassis module 40 has a length and a stance to support a crane 42, when under load.

Control Module positioning: the control module can be positioned toward the front of the front chassis module, toward the rear of the rear chassis module, toward the rear of the front chassis module or toward the front of the rear chassis module. Referring to FIGS. 1, through 3, 6 and 7 there is illustrated the most common version in which control module 24 is at the front of front chassis module 14. Referring to FIG. 4, there is illustrated a version in which control module 24 is positioned toward the rear of rear chassis module 16. Referring to FIG. 5, there is illustrated a version in which control module 24 is positioned toward the rear of front chassis module 14.

Motor module positioning: the motor module may be mounted on whichever chassis will benefit from the additional weight. In the illustrated embodiments motor module 22 is placed alongside of control module 24. This is for convenience in running necessary control cables (not shown). Motor module 22 can be placed independently of the positioning of control module 24.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

1. A method of making a modular vehicle, comprising the steps of:
maintaining an inventory of:
chassis modules having opposed sides and opposed ends;
wheel and suspension modules including steer-able wheel and suspension modules having steering capability, drive wheel and suspension modules having an internal drive adapted to rotate the wheel, and dual function wheel and suspension modules having both steering capability and drive capability;
motor modules to provide motive force to drive components; and
control modules having a driver compartment with steering controls and motor controls;
coupling at least two chassis modules in end to end relation by a coupling which permits pivotal movement about a substantially vertical pivot axis, while accommodating pitch and yaw;
detachably mounting a control module on one of the at least two chassis modules;
detachably mounting a motor module on one of the at least two chassis modules;
detachably mounting wheel suspension modules having required steering and drive performance characteristics to the opposed sides of each of the at least two chassis modules in a manner which supports movement of the chassis modules over a ground surface.

2. The method as defined in claim 1, wherein the modules are detachably mounted by bolts.

3. A modular vehicle, comprising:
at least two chassis modules, each of the chassis modules having opposed sides, opposed ends, the at least two chassis modules being coupled in end to end relation by a coupling which permits pivotal movement about a substantially vertical pivot axis, while accommodating pitch and yaw;
at least one pair of wheel and suspension modules detachably secured to each of the chassis modules in a manner which supports movement of the chassis modules over a ground surface, with one wheel and suspension module of each pair secured to each of the opposed sides of the chassis module, at least one of the pairs of wheel and suspension modules each having steering capability and at least one of the pairs of wheel and suspension modules each having a drive adapted to rotate the wheel;
at least one of the at least two chassis modules having a motor module mounted thereon which is adapted to provide motive force to each drive for the wheels;
at least one of the at least two chassis modules having a control module mounted thereon with steering controls and motor controls.
